(19) United States
(12) Patent Application Publication
(10) Pub. No.: US 2004/0234663 A1
(43) Pub. Date: Nov. 25, 2004

(54) Bread-making additive and bread-making composition

(75) Inventors: Hirofumi Motoi, Iruma-gun (JP); Yosuke Kikuchi, Iruma-gun (JP); Takahiro Yagishita, Iruma-gun (JP); Koji Takeya, Iruma-gun (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: NISSHIN SEIFUN GROUP INC., Tokyo (JP)

(21) Appl. No.: 10/795,392

(22) Filed: Mar. 9, 2004

(30) Foreign Application Priority Data
Mar. 10, 2003 (JP) 2003-062843
Dec. 1, 2003 (JP) 2003-401015

(51) Int. Cl. A21D 10/00

(52) U.S. Cl. 426/549

(57) ABSTRACT

Provided are a bread-making additive containing a water-insoluble resistant starch and a gluten; and a bread-making composition containing the additive and a grain powder. By using this additive or composition, breads excellent in crust, crumb, texture and the like can be made.

### BACKGROUND OF THE INVENTION

1. Field of the Invention

The present invention relates to a bread-making additive and a bread-making composition.

2. Background Art

In recent years, intake of diets made of purified raw materials has caused a reduction in stool volume, a decrease in stool frequency and prolongation of stool transit time through the gastrointestinal tract. This is thought to increase the contact time between the intestinal mucous membrane and a carcinogen and heighten the risk of cancers.

Resistant starches are recently known to be effective for the prevention or treatment of gastrointestinal, particularly colorectal diseases, and various diets having such a starch incorporated therein have been proposed.

As such diets, known are: a diet having up to 10% of a concoction composed mainly of a starch containing more than 55% (w/w) pancreatin resistant starch (RS) which consists essentially of α-glucans having a DP of from 10 to 35 and a DSC melting temperature of 115° C. or lower (refer to Japanese Patent Laid-Open No. 191931/1998), a food composition having an increased dietary fiber content, wherein the dietary fibers contain a starch which is derived from a grain, a portion thereof or a combination of the grain and the portion thereof, has an amylose content of at least about 80% (w/w) and is substantially free from chemical modification; the starch provides a resistant starch in an amount enough for satisfying the increased food fiber content in the food composition; and the starch is a corn starch and the grain and the portion thereof are each a corn (refer to Japanese Patent No. 3249125); and a diet containing a resistant granular starch available by heating, at 60 to 160° C., a high amylose starch having an amylose content of at least 40 wt and having a total moisture content of from 10 to 80 wt. % in order to provide a starch having a total dietary fiber content of at least 12% (refer to Japanese Patent Application Laid-Open No. 12601/1997).

When such a resistant starch or resistant granular starch as described above is used for bread-making, however, it considerably deteriorates the volume, crust, crumb, palatability and flavor of the bread, particularly, it accelerates the staling of the bread. Thus, it is impossible to make breads having sufficient qualities by using such a starch.

With a view to making breads having excellent qualities even when an resistant starch is added thereto, the present inventors have proceeded with an investigation. As a result, it has been found that, breads having excellent qualities are available by using, in combination with a water-insoluble resistant starch, a specific additive selected depending on the property of the starch, leading to the completion of the present invention.

In the present invention, there are thus provided a bread-making additive obtained by adding, to a water-insoluble resistant starch, a gluten, and optionally an enzyme preparation and an emulsifier; and a bread-making composition containing the bread-making additive and a grain powder.

When a bread is made using the bread-making additive or bread-making composition of the present invention, the dough has improved machinability and in addition, the bread has excellent crust, crumb and texture even if it contains a water-insoluble resistant starch.

### DETAILED DESCRIPTION OF THE INVENTION

The water-insoluble resistant starch to be used in the present invention can usually be obtained by subjecting a starch to limited hydrolysis with amylase and then adding a debranching enzyme to react it with the hydrolysate. As the water-insoluble resistant starch, a starch containing at least 50 wt. % of an resistant starch can be preferably employed. The water-insoluble resistant starch having a particle size as fine as 100 μm or less is especially preferred.

Examples of the starch to be used as a raw material include corn starch, sago starch, flour starch, rice starch, potato starch, sweet potato starch, and tapioca starch, and derivatives thereof. Depending on the using purpose, a proper one is selected from them and provided for use.

The content of the resistant starch in the water insoluble resistant starch of the present invention can be determined by the Megazyme method which will be described below.

Determination Method of Resistant Starch

A: Reagents (Assay Kit of Megazyme International Ireland Ltd.)

(1) Pancreatin (pancreatic α-amylase)

(2) Amyloglucosidase concentrated solution

(3) Glucose determination reagent (GOPOD)

(4) Glucose standard solution

A mixture of pancreatin and amyloglucosidase solution is prepared in advance in the following manner. The whole amount of a solution obtained by dissolving 1 g of pancreatin in 100 ml of a 0.1M sodium maleate buffer (pH 6.0) and a 1 ml portion of a solution obtained by diluting 2 ml of the amyloglucosidase concentrated solution with 20 ml of a 0.1M sodium maleate buffer (pH 6) are mixed.

B: Measuring Method

(1) Sample collection: A sample (100 mg) is collected in a test tube with a lid.

(2) Degradation with enzyme 1: In the test tube is charged 4 ml of the mixture of pancreatin and amyloglucosidase solution. The tube is covered with the lid, and then with the longer side down, the tube is shaken in a water bath of 37° C. to react them for 16 hours.

(3) Treatment of the reaction mixture: To the reaction mixture is added 4 ml of modified ethanol (95% ethanol+5% methanol), followed by stirring.

(4) Centrifugal separation 1: The mixture is centrifuged at 1500G for 10 minutes and the supernatant is discarded.

(5) Centrifugal separation 2: Modified ethanol (6 ml) is added, and after washing the precipitate well therewith, centrifugal separation is conducted again under similar conditions. The supernatant is discarded.

(6) Centrifugal separation 3: Modified ethanol (6 ml) is added, and after washing the precipitate well therewith, centrifugal separation is conducted again under similar conditions. The supernatant is discarded.

(7) Treatment of the precipitate: To the precipitate is added 3 ml of a 2M potassium hydroxide solution, followed by stirring for 30 minutes. Then, 8 ml of a 1.2M sodium acetate buffer (pH 3.8) is added.

(8) Degradation with enzyme 2: After addition of 0.1 ml of the amyloglucosidase concentrated solution, the mixture is reacted by shaking it in a water bath of 50° C. for 30 minutes.

(9) Determination of glucose 1: In a 100 ml of a measuring flask, the content is transferred from the test tube and its amount is adjusted to 100 ml with distilled water. After sufficient stirring and centrifugation at 1500G for 10 minutes, the supernatant is collected as a sample.

(10) Determination of glucose 2: An aqueous standard solution of glucose is prepared for the construction of a calibration curve.

(11) Determination of glucose 3: The sample, the aqueous standard solution of glucose, and a 0.1M sodium acetate buffer (pH 4.5) as a blank were each charged in a test tube in an amount of 0.1 ml. To the test tube is added 3 ml of the glucose determination reagent (GOPOD) and they are reacted in a water bath of 50° C. for 20 minutes.

(12) Determination of glucose 4: The absorbance at 510 nm is measured. The glucose concentration of the sample is calculated from the calibration curves drawn using the aqueous standard solution of glucose and blank, and the glucose in the sample is quantitatively determined.

C. Determination of Resistant Starch

The amount of the resistant starch is obtained by multiplying the amount of glucose by 0.9.

The amylose content in the starch to be used in the present invention can be determined by the following iodine affinity measuring method.

Determination Method of Amylose Content

In 2 to 3 mL of pure water, about 30 mg of starch granules which have been degreased well in advance is suspended. After the addition of 2.5 mL of 5N KOH to gelatinize the resulting suspension, pure water is added in portions to completely dissolve the starch granules therein and to give a total amount of 25 mL.

In a 200 mL of beaker, 10 mL of the starch solution is weighed accurately. Then, 75 mL of pure water, 10 mL of 1N hydrochloric acid and 5 mL of 0.4N KI were added, followed by thorough mixing by a stirrer. While stirring, a 0.00157N potassium iodate (KIO₃) solution was titrated at a rate of from 0.5 to 1.0 mL/minute by using a peristaltic pump or the like. A change in the electric current between platinum electrodes to which a voltage of about 25 mV has been applied is recorded on a recording paper. The titration amount of KIO₃ is determined from an inflection point of the titration curve on the recording paper. The blank test is conducted without adding the starch.

From the titration amount of KIO₃, the iodine affinity is found by the below-described equation.

$$\begin{matrix}lodine affinity \\ ( mg iodine \text{/} 100 mg of sample )\end{matrix} = titration amount of KIO3 ( mL ) \times \\ 0.2 ( mg \text{/} mL ) \times \\ \frac{( 100 mg )}{\begin{matrix}Total saccharide amount \\ ( mg ) in 10 mL of sample\end{matrix}}$$

In a similar operation to that employed for the determination of iodine affinity of the sample, the iodine affinity of standard amylose is found and in accordance with the following equation, the amylose content in the sample is calculated.

$$Amylose content ( \% ) = \frac{lodine affinity of sample}{lodine affinity of standard amylose} \times 100$$

The water-insoluble resistant starch to be used in the present invention must be derived from a starch having an amylose content of from 10 to 30 wt. %, especially from 15 to 25 wt. %, when a gluten or a gluten and an enzyme preparation are added. When a gluten, enzyme preparation and emulsifier are added, any water insoluble resistant starch is usable irrespective of its amylose content.

As the gluten to be used for the bread-making additive or bread-making composition of the present invention, active gluten can be employed. This gluten is effective in smaller amounts than that presumed from a decrease in the protein amount in the bread-making composition caused by the incorporation of the starch.

Examples of the enzyme preparation include amylase preparation, hemicellulase preparation, lipase preparation and glucose oxidase preparation.

Examples of the emulsifier to be used in the present invention include glycerin fatty acid esters, sucrose fatty acid esters, lecithin, diacetyltartaric acid monoglyceride and succinic monoglyceride.

In the bread-making additive or bread-making composition according to the present invention, the water-insoluble resistant starch, gluten, enzyme preparation and emulsifier are added preferably at a ratio of 100:3.3 to 20:0.03 to 2:0.3 to 2, especially preferably 100:10 to 20:1 to 2:1 to 2.

Upon preparation of the bread-making additive or bread-making composition of the present invention, an extender such as wheat flour or starch may be added.

Examples of the grain powder to be used for the bread-making composition of the present invention include wheat flour, rye flour, rice flour, barley flour and oats flour.

It is preferred to use the bread-making additive or bread-making composition according to the present invention so that the resistant starch in the water-insoluble resistant starch would be contained in the grain powder to be used as a bread-making raw material in an amount of from 5 to 15 wt. %, preferably from 5 to 10 wt. %. When the amount of the resistant starch in the water-insoluble digestible starch is less than 5 wt. %, it cannot offer functionality to the bread. Amounts exceeding 15 wt. %, on the other hand, deteriorate the bread-making property.

Upon bread-making in the present invention, proper subsidiary raw materials selected as needed from yeasts, yeast foods, saccharides, salt, oils or fats, egg and milk products can be used.

Examples of the bread-making method using the bread-making additive or bread-making composition of the present invention include straight dough method, sponge dough method, liquid sponge method, sour dough method, method using a dough made of koji, rice, boiled rice and water, warm dough method, dough method using hop, chu-men method in which activated yeast is added in the later stage, Chorleywood method, continuous bread-making method, and frozen dough method. Of these, sponge dough method is especially preferred.

### EXAMPLES

The present invention will hereinafter be described more specifically by Examples. It should however be borne in mind that the present invention is not limited only to the below-described examples.

### Examples 1 to 5, Comparative Example 1

White loaf was made by using bread-making raw materials as shown in Table 1 under the production conditions of Table 2.

The white loaf thus made was evaluated by a panel of 10 experts based on the criteria as shown in Table 3. The evaluation results are shown in Table 4.

TABLE 1

| | Control | | | | | | Comp. |
|---|---|---|---|---|---|---|---|
| Raw materials for bread-making | Ex. 1 | Ex. 1 | Ex. 2 | Ex. 3 | Ex. 4 | Ex. 5 | Ex. 1 |
| Hard flour (*1) (parts by weight) | 100 | 90 | 80 | 70 | 70 | 70 | 90 |
| Water-insoluble resistant starch (*2) | 0 | 10 | 20 | 30 | 20 | 0 | 0 |
| (parts by weight) | | | | | | | |
| Water-insoluble resistant starch (*3) | 0 | 0 | 0 | 0 | 10 | 0 | 0 |
| (parts by weight) | | | | | | | |
| Powdery water-insoluble resistant starch | 0 | 0 | 0 | 0 | 0 | 30 | 0 |
| (*4) (parts by weight) | | | | | | | |
| Water soluble resistant starch (*5) (parts | 0 | 0 | 0 | 0 | 0 | 0 | 10 |
| by weight) | | | | | | | |
| Gluten (*6) (parts by weight) | 2 | | | | | | |
| Enzyme preparation (*7) (parts by | 0.1 | | | | | | |
| weight) | | | | | | | |
| Emulsifier (*8) (parts by weight) | 0.2 | | | | | | |
| Yeast (parts by weight) | 2.5 | | | | | | |
| Yeast food (parts by weight) | 0.1 | | | | | | |
| Salt (parts by weight) | 2 | | | | | | |
| Sugar (parts by weight) | 5 | | | | | | |
| Skim milk (parts by weight) | 2 | | | | | | |
| Shortening (parts by weight) | 5 | | | | | | |
| Water (parts by weight) | 65 | | | | | | |
| Converted protein content (wt. %) | 13.3 | 12.2 | 11.0 | 9.8 | 9.8 | 9.8 | 12.2 |

(*1) “Million” (trade name; product of Nisshin Flour Milling Inc., protein content: 12 wt. %)
(*2) “ActiStar” (trade name; product of Cerestar, resistant starch content: 53 wt. %)
(*3) “Loadstar” (trade name; product of Nihon Shokuhin Kako, resistant starch content: 56 wt. %)
(4*) Fine powder having a particle size of 100 μm or less obtained by sifting “ActiStar”.
(5*) “Fibersol-2” (trade name; product of Matsutani Chemical Industry, resistant starch content: 0 wt. %)
(6*) “Emasoft EX-100” (trade name; product of Riken Vitamin, protein content: 80 wt. %)
(*7) “Hemicellulase 90” (trade name; product of Amano Enzyme)
(*8) “Myverol SMG-K” (sold by Koyo Mercantile)

TABLE 2
[Bread-making step (straight dough method, white loaf)]

| | |
|---|---|
| Mixing: | 2 minutes at low speed, 5 minutes at medium |
| | speed, (addition of shortening), 3 minutes at |
| | medium speed, and 2 minutes at high speed. |
| Dough temperature | 27° C. |
| after mixing: | |
| Fermentation time: | 90 minutes (27° C., 75%) |
| Weight of each | 250 g/piece. The |
| divided piece: | dough is divided, followed by rounding. |
| Bench time: | 20 minutes |
| Shaping: | Each piece is punched down, rolled into a |
| | long strip, and molded into a U-shaped roll. Six |
| | pieces are filled in a 3-loaf pan. |
| Proofing: | 45 minutes (38° C., 85%) |
| Baking: | 38 minutes (220° C.) |

TABLE 3

| What is | | |
|---|---|---|
| evaluated | Scores | Criteria for evaluation |
| Crust | 5 | The bread is baked very evenly with a nice golden brown |
| | | color. |
| | 4 | The bread is baked evenly with a golden brown color. |
| | 3 | The bread is baked a little unevenly with an almost golden |
| | | brown color. |
| | 2 | The bread is baked quite unevenly with a little golden brown |
| | | color. |
| | 1 | The bread is baked very unevenly with not a golden but |
| | | brown color. |
| Crumb structure | 5 | The bread has a very uniform cell structure with very thin |
| | | cell walls. |
| | 4 | The bread has a uniform cell structure with thin cell walls. |
| | 3 | The bread has a little coarse cell structure with slightly thin |
| | | cell walls. |
| | 2 | The bread has a coarse cell structure with slightly thick cell |
| | | walls. |
| | 1 | The bread has a very coarse cell structure with thick cell |
| | | walls. |
| Texture · odor | 5 | The bread is very soft, provides excellent palatability and is |
| | | utterly free from an offensive odor. |
| | 4 | The bread is soft, provides good palatability and is free from |
| | | an offensive odor. |
| | 3 | The bread is a little soft, provides palatability and is almost |
| | | free from an offensive odor. |
| | 2 | The bread is a little hard, provides a little inferior palatability |
| | | and gives a little offensive odor. |
| | 1 | The bread is hard, provides inferior palatability and gives an |
| | | offensive odor. |

TABLE 4

| | Control | | | | | | Comp. |
|---|---|---|---|---|---|---|---|
| What is evaluated | 1 | Ex. 1 | Ex. 2 | Ex. 3 | Ex. 4 | Ex. 5 | Ex. 1 |
| Crust | 3.2 | 4.0 | 4.3 | 2.8 | 3.8 | 4.0 | 1.8 |
| Crumb structure | 2.9 | 4.8 | 3.8 | 4.0 | 4.2 | 4.3 | 1.7 |
| Texture · odor | 2.8 | 4.2 | 4.2 | 3.9 | 4.0 | 4.1 | 2.2 |
| Total | 8.9 | 13.0 | 12.3 | 10.7 | 12.0 | 12.4 | 5.7 |

### Examples 6 to 16

White loaf was made by using the bread raw materials as shown in Tables 5 and 6 under the production conditions of Table 2.

The white loaf thus made was evaluated by a panel of 10 experts based on the criteria in Table 3. The evaluation results are as shown in Tables 7 and 8.

TABLE 5

| Raw materials for bread-making | Ex. 6 | Ex. 7 | Ex. 8 | Ex. 9 | Ex. 10 | Ex. 11 |
|---|---|---|---|---|---|---|
| Hard flour (*9) (parts by weight) | 90 | 90 | 90 | 90 | 90 | 90 |
| Water-insoluble resistant starch (*10) (parts by weight) | 10 | 10 | 10 | 10 | 10 | 10 |
| Gluten (*11) (parts by weight) | 0.33 | 1 | 2 | 2 | 2 | 2 |
| Enzyme preparation (*12) (parts by weight) | 0.1 | 0.1 | 0.003 | 0.2 | 0.1 | 0.1 |
| Emulsifier (*13) (parts by weight) | 0.2 | 0.2 | 0.2 | 0.2 | 0.03 | 0.1 |
| Yeast (parts by weight) | 2.5 | | | | | |
| Yeast food (parts by weight) | 0.1 | | | | | |
| Salt (parts by weight) | 2 | | | | | |
| Sugar (parts by weight) | 5 | | | | | |
| Skim milk (parts by weight) | 2 | | | | | |
| Shortening (parts by weight) | 5 | | | | | |
| Water (parts by weight) | 65 | | | | | |
| Converted protein content (wt. %) | 11.0 | 11.5 | 12.2 | 12.2 | 12.2 | 12.2 |

(*9) “Million” (trade name; product of Nisshin Flour Milling Inc., protein content: 12 wt. %)
(*10) “ActiStar” (trade name; product of Cerestar, resistant starch content: 53 wt. %)
(*11) “Emasoft EX-100” (trade name; product of Riken Vitamin, protein content: 80 wt. %)
(*12) “Hemicellulase 90” (trade name; product of Amano Enzyme)
(*13) “Myverol SMG-K” (sold by Koyo Mercantile)

TABLE 6

| Raw materials for bread-making | Ex. 12 | Ex. 13 | Ex. 14 | Ex. 15 | Ex. 16 |
|---|---|---|---|---|---|
| Hard flour (*14) (parts by weight) | 90 | 90 | 90 | 90 | 90 |
| Water-insoluble resistant starch (*15) (parts by weight) | 10 | 10 | 10 | 10 | 10 |
| Gluten A (*16) (parts by weight) | 0 | 2 | 2 | 2 | 2 |
| Gluten B (*17) (parts by weight) | 2 | 0 | 0 | 0 | 0 |
| Enzyme preparation A (*18) (parts by weight) | 0.1 | 0 | 0 | 0.1 | 0.1 |
| Enzyme preparation B (*19) (parts by weight) | 0 | 0.1 | 0 | 0 | 0 |
| Enzyme preparation C (*20) (parts by weight) | 0 | 0 | 0.1 | 0 | 0 |
| Emulsifier A (*21) (parts by weight) | 0.2 | 0.2 | 0.2 | 0 | 0 |
| Emulsifier B (*22) (parts by weight) | 0 | 0 | 0 | 0.2 | 0 |
| Emulsifier C (*23) (parts by weight) | 0 | 0 | 0 | 0 | 0.2 |
| Yeast (parts by weight) | 2.5 | | | | |
| Yeast food (parts by weight) | 0.1 | | | | |
| Salt (parts by weight) | 2 | | | | |
| Sugar (parts by weight) | 5 | | | | |
| Skim milk (parts by weight) | 2 | | | | |
| Shortening (parts by weight) | 5 | | | | |
| Water (parts by weight) | 65 | | | | |
| Converted protein content (wt. %) | 12.2 | 12.2 | 12.2 | 12.2 | 12.2 |

(*14) “Million” (trade name; product of Nisshin Flour Milling Inc., protein content: 12 wt. %)
(*15) “ActiStar” (trade name; product of Cerestar, resistant starch content: 53 wt. %)
(*16) “Emasoft EX-100” (trade name; product of Riken Vitamin, protein content: 80 wt. %)
(*17) “A-glu WP” (trade name; product of Glico Foods, protein content: 80 wt. %)
(*18) “Hemicellulase 90” (trade name; product of Amano Enzyme)
(*19) “Novamyl 1000 BG α-amylase” (trade name; product of Novozymes Japan)
(*20) “Gluzyme: glucose oxidase” (trade name; product of Novozymes Japan)
(*21) “Myverol SMG-K” (sold by Koyo Mercantile)
(*22) “RYOTO Sugar Ester P-1670” (trade name; product of Mitsubishi-Kagaku Foods Corporation)
(*23) “Emulsie MM-100” (trade name; product of Riken Vitamin)

TABLE 7

| | | | | | Example | Example |
|---|---|---|---|---|---|---|
| What is evaluated | Example 6 | Example 7 | Example 8 | Example 9 | 10 | 11 |
| Crust | 3.6 | 4.0 | 3.6 | 4.0 | 3.5 | 4.0 |
| Crumb structure | 4.1 | 4.7 | 4.3 | 4.6 | 4.2 | 4.7 |
| Texture · odor | 4.0 | 4.5 | 4.0 | 4.4 | 3.9 | 4.4 |
| Total | 11.7 | 13.2 | 11.9 | 13.0 | 11.6 | 13.1 |

TABLE 8

| What is evaluated | Example 12 | Example 13 | Example 14 | Example 15 | Example 16 |
|---|---|---|---|---|---|
| Crust | 4.1 | 3.8 | 3.6 | 4.1 | 4.2 |
| Crumb structure | 4.7 | 4.3 | 4.3 | 4.3 | 4.0 |
| Texture · odor | 4.3 | 4.0 | 4.1 | 4.4 | 4.1 |
| Total | 13.1 | 12.1 | 12.0 | 12.8 | 12.3 |

### Examples 17 to 27, Comparative Example 2

Bread-making raw materials as shown in Tables 9 and 10 were used and white loaf was made under the conditions of Table 11.

The white loaf thus made was then evaluated by a panel of 10 experts based on the criteria shown in Table 12. The evaluation results are shown in Tables 13 and 14.

TABLE 9

| | Control | | | | | | | | | | | |
|---|---|---|---|---|---|---|---|---|---|---|---|---|
| | Example 2 | | Example 17 | | Example 18 | | Example 19 | | Example 20 | | Example 21 | |
| Raw materials for bread-making | Sponge | Dough | Sponge | Dough | Sponge | Dough | Sponge | Dough | Sponge | Dough | Sponge | Dough |
| Hard flour (*24) (parts by weight) | 70 | 30 | 70 | 20 | 70 | 10 | 70 | 0 | 70 | 20 | 70 | 20 |
| Water-insoluble resistant starch | — | 0 | — | 10 | — | 20 | — | 30 | — | 10 | — | 10 |
| (*25) (parts by weight) | | | | | | | | | | | | |
| Gluten (*26) (parts by weight) | — | 0 | — | 2 | — | 2 | — | 2 | — | 2 | — | 2 |
| Enzyme preparation (*27) | — | 0 | — | 0 | — | 0 | — | 0 | — | 0.1 | — | 0.1 |
| (parts by weight) | | | | | | | | | | | | |
| Emulsifier (*28) (parts by weight) | — | 0 | — | 0 | — | 0 | — | 0 | — | 0 | — | 0.2 |
| Yeast (parts by weight) | 2.5 | — | 2.5 | — | 2.5 | — | 2.5 | — | 2.5 | — | 2.5 | — |
| Yeast food (parts by weight) | 0.1 | — | 0.1 | — | 0.1 | — | 0.1 | — | 0.1 | — | 0.1 | — |
| Salt (parts by weight) | — | 2 | — | 2 | — | 2 | — | 2 | — | 2 | — | 2 |
| Sugar (parts by weight) | — | 5 | — | 5 | — | 5 | — | 5 | — | 5 | — | 5 |
| Skim milk (parts by weight) | — | 2 | — | 2 | — | 2 | — | 2 | — | 2 | — | 2 |
| Shortening (parts by weight) | — | 5 | — | 5 | — | 5 | — | 5 | — | 5 | — | 5 |
| Water (parts by weight) | 40 | 30 | 40 | 30 | 40 | 30 | 40 | 30 | 40 | 30 | 40 | 30 |

| | | | | | | |
|---|---|---|---|---|---|---|
| Converted protein content (wt. %) | 12.0 | 12.2 | 11.0 | 9.8 | 12.2 | 12.2 |

(*24) “Million” (trade name; product of Nisshin Flour Milling Inc., protein content: 12 wt. %)
(*25) “ActiStar” (trade name; product of Cerestar, resistant starch content: 53 wt. %)
(*26) “Emasoft EX-100” (trade name; product of Riken Vitamin, protein content: 80 wt. %)
(*27) “Hemicellulase 90” (trade name; product of Amano Enzyme)
(*28) “Myverol SMG-K” (sold by Koyo Mercantile)

TABLE 10

| Bread-making | Example 22 | | Example 23 | | Example 24 | | Example 25 | | Example 26 | | Example 27 | | Example 28 | |
|---|---|---|---|---|---|---|---|---|---|---|---|---|---|---|
| raw materials | Sponge | Dough | Sponge | Dough | Sponge | Dough | Sponge | Dough | Sponge | Dough | Sponge | Dough | Sponge | Dough |
| Hard flour | 70 | 20 | 70 | 20 | 70 | 20 | 70 | 20 | 70 | 20 | 70 | 20 | 70 | 20 |
| (*29) | | | | | | | | | | | | | | |
| (parts by | | | | | | | | | | | | | | |
| weight) | | | | | | | | | | | | | | |
| Water- | — | 10 | — | 10 | — | 10 | — | 10 | — | 10 | — | 10 | — | 10 |
| insoluble | | | | | | | | | | | | | | |
| resistant | | | | | | | | | | | | | | |
| starch (*30) | | | | | | | | | | | | | | |
| (parts by | | | | | | | | | | | | | | |
| weight) | | | | | | | | | | | | | | |
| Gluten (*31) | — | 0.33 | — | 1 | — | 2 | — | 2 | — | 2 | — | 2 | — | 0 |
| (parts by | | | | | | | | | | | | | | |
| weight) | | | | | | | | | | | | | | |
| Enzyme | — | 0.1 | — | 0.1 | — | 0.003 | — | 0.2 | — | 0.1 | — | 0.1 | — | 0 |
| preparation | | | | | | | | | | | | | | |
| (*32) | | | | | | | | | | | | | | |
| (parts by | | | | | | | | | | | | | | |
| weight) | | | | | | | | | | | | | | |
| Emulsifier | — | 0.2 | — | 0.2 | — | 0.2 | — | 0.2 | — | 0.03 | — | 0.1 | — | 0 |
| (*33) | | | | | | | | | | | | | | |
| (parts by | | | | | | | | | | | | | | |
| weight) | | | | | | | | | | | | | | |
| Yeast | 2.5 | — | 2.5 | — | 2.5 | — | 2.5 | — | 2.5 | — | 2.5 | — | 2.5 | — |
| (parts by | | | | | | | | | | | | | | |
| weight) | | | | | | | | | | | | | | |
| Yeast food | 0.1 | — | 0.1 | — | 0.1 | — | 0.1 | — | 0.1 | — | 0.1 | — | 0.1 | — |
| (parts by | | | | | | | | | | | | | | |
| weight) | | | | | | | | | | | | | | |
| Salt | — | 2 | — | 2 | — | 2 | — | 2 | — | 2 | — | 2 | — | 2 |
| (parts by | | | | | | | | | | | | | | |
| weight) | | | | | | | | | | | | | | |
| Sugar | — | 5 | — | 5 | — | 5 | — | 5 | — | 5 | — | 5 | — | 5 |
| (parts by | | | | | | | | | | | | | | |
| weight) | | | | | | | | | | | | | | |
| Skim milk | — | 2 | — | 2 | — | 2 | — | 2 | — | 2 | — | 2 | — | 2 |
| (parts by | | | | | | | | | | | | | | |
| weight) | | | | | | | | | | | | | | |
| Shortening | — | 5 | — | 5 | — | 5 | — | 5 | — | 5 | — | 5 | — | 5 |
| (parts by | | | | | | | | | | | | | | |
| weight) | | | | | | | | | | | | | | |
| Water | 40 | 30 | 40 | 30 | 40 | 30 | 40 | 30 | 40 | 30 | 40 | 30 | 40 | 30 |
| (parts by | | | | | | | | | | | | | | |
| weight) | | | | | | | | | | | | | | |

| | | | | | | | |
|---|---|---|---|---|---|---|---|
| Converted | 11.0 | 11.5 | 12.2 | 12.2 | 12.2 | 12.2 | 10.8 |
| protein | | | | | | | |
| content | | | | | | | |
| (wt. %) | | | | | | | |

(*29) “Million” (trade name; product of Nisshin Flour Milling Inc., protein content: 12 wt. %)
(*30) “ActiStar” (trade name; product of Cerestar, resistant starch content: 53 wt. %)
(*31) “Emasoft EX-100” (trade name; product of Riken Vitamin, protein content: 80 wt. %)
(*32) “Hemicellulase 90” (trade name; product of Amano Enzyme)
(*33) “Myverol SMG-K” (sold by Koyo Mercantile)

TABLE 11
[(Bread-making step (70% sponge dough method, white loaf)]
Sponge

| | |
|---|---|
| Mixing: | 3 minutes at low speed, and 3 minutes at |
| | high speed. |
| Dough temperature | 24° C. |
| after mixing: | |
| Fermentation time: | 4 hours (27° C., 75%) |
| End-point | 29° C. |
| temperature: | |

Dough

| | |
|---|---|
| Mixing: | 4 minutes at low speed, 6 minutes at high |
| | speed, (addition of shortening), 3 minutes at low |
| | speed, 5 minutes at high speed. |
| Dough temperature | 27° C. |
| after mixing: | |
| Floor time: | 20 minutes |
| Weight of each | 250 g/piece. The |
| divided piece: | dough is divided, followed by rolling. |
| Bench time: | 25 minutes |
| Shaping: | Each piece is punched down, rolled into a |
| | long strip, and molded into a swiss roll. Six pieces |
| | are filled in a 3-loaf pan. |
| Proofing: | 45 minutes (38° C., 85%) |
| Baking: | 38 minutes (220° C.) |

TABLE 12

| What is evaluated | Scores | Criteria for evaluation |
|---|---|---|
| Loaf volume | 5 | Excellent with a great loaf volume |
| | 4 | Good with an adequate loaf volume |
| | 3 | The loaf volume is not so large. |
| | 2 | Inferior with a small loaf volume |
| | 1 | Inferior with a very small loaf volume. |
| Crust | 5 | The bread is baked very evenly with a nice golden brown |
| | | color. |
| | 4 | The bread is baked evenly with a golden brown color. |
| | 3 | The bread is baked a little unevenly with an almost golden |
| | | brown color and has some cracks in the crust. |
| | 2 | The bread is baked unevenly with a little golden brown |
| | | color and has cracks in the crust. |
| | 1 | The bread is baked very unevenly with not a golden but |
| | | brown color and many cracks in the crust. |
| Crumb structure | 5 | The bread has a very uniform cell structure with very thin |
| | | cell walls. |
| | 4 | The bread has a uniform cell structure with thin cell walls. |
| | 3 | The bread has a little coarse cell structure with slightly thin |
| | | cell walls. |
| | 2 | The bread has a coarse cell structure with slightly thick |
| | | cell walls. |
| | 1 | The bread has a very coarse cell structure with thick cell |
| | | walls. |
| Texture · odor | 5 | The bread is very soft, provides excellent palatability and |
| | | is utterly free from an offensive odor. |
| | 4 | The bread is soft, provides good palatability and is free |
| | | from an offensive odor. |
| | 3 | The bread is a little soft, provides palatability and is almost |
| | | free from an offensive odor. |
| | 2 | The bread is a little hard, provides a little inferior |
| | | palatability and gives a little offensive odor. |
| | 1 | The bread is hard, provides inferior palatability and gives |
| | | an offensive odor. |

TABLE 13

| | Control | Example | Example | Example | Example | Example |
|---|---|---|---|---|---|---|
| What is evaluated | Example 2 | 17 | 18 | 19 | 20 | 21 |
| Loaf volume | 3.8 | 4.2 | 4.4 | 3.8 | 4.8 | 4.9 |
| Crust | 3.8 | 3.4 | 3.3 | 3.3 | 4.8 | 4.9 |
| Crumb structure | 3.6 | 4.1 | 4.4 | 4.1 | 4.7 | 4.9 |
| Texture · odor | 3.8 | 4.0 | 4.3 | 3.9 | 4.6 | 4.6 |
| Total | 15.0 | 15.7 | 16.4 | 15.1 | 18.9 | 19.3 |

TABLE 14

| | Example | Example | Example | Example | Example | Example | Comp. |
|---|---|---|---|---|---|---|---|
| What is evaluated | 22 | 23 | 24 | 25 | 26 | 27 | Ex. 2 |
| Loaf volume | 4.6 | 4.7 | 4.5 | 4.5 | 4.2 | 4.8 | 3.6 |
| Crust | 4.7 | 4.8 | 4.6 | 4.8 | 4.4 | 4.9 | 3.2 |
| Crumb structure | 4.5 | 4.8 | 4.3 | 4.8 | 4.3 | 4.8 | 3.3 |
| Texture · odor | 4.8 | 5.0 | 4.4 | 4.4 | 4.6 | 4.5 | 3.4 |
| Total | 18.6 | 19.3 | 17.8 | 18.5 | 17.6 | 19.0 | 13.5 |

What is claimed is:

1. A bread-making additive, which comprises a water-insoluble resistant starch and a gluten, wherein the water-insoluble resistant starch is derived from a starch having an amylose content of from 10 to 30% and a gluten.

2. A bread-making additive, which comprises a water-insoluble resistant starch, a gluten and an enzyme preparations, wherein the water-soluble resistant starch is derived from a starch having an amylose content of from 10 to 30%.

3. A bread-making additive, which comprises a water-insoluble resistant starch, gluten, an enzyme preparation and an emulsifier.

4. A bread-making composition, which comprises a grain powder and a bread-making additive as claimed in any one of claims 1 to 3.
